(19) United States
(12) Patent Application Publication
(10) Pub. No.: US 2009/0170424 A1
(43) Pub. Date: Jul. 2, 2009

(54) LOW POWER MODE FOR SDARS RECEIVER

(75) Inventors: Robert Conrad Malkemes, Bricktown, NJ (US); Jie Song, Germantown, MD (US)

Correspondence Address: RYAN, MASON & LEWIS, LLP, 90 FOREST AVENUE, LOCUST VALLEY, NY, 11560, US

(73) Assignee: Agere Systems, Inc., Allentown, PA (US)

(21) Appl. No.: 11/967,643

(22) Filed: Dec. 31, 2007

(51) Int. Cl. H04H 20/74

(52) U.S. Cl. 455/3.02

(57) ABSTRACT

The present invention implements a method and system for receiving content in a Satellite Digital Audio Radio Service (SDARS) system. The method includes receiving a first signal stream in an SDARS receiver, the first signal stream including the SDARS content. The method further includes receiving a second signal stream in the SDARS receiver, the second signal stream including the SDARS content, the second signal stream being delayed relative to the first signal stream by a predetermined delay time. The method further includes combining the first signal stream and the second signal stream in to a composite signal that includes the SDARS content. The method further includes powering off a portion of the SDARS receiver, wherein the powering off of the portion of the SDARS receiver does not cause a disruption in the composite signal.

### FIELD OF THE INVENTION

The invention pertains to Satellite Digital Audio Radio Service (SDARS). More particularly, the invention pertains to a method and apparatus for reducing the power consumed by a SDARS receiver.

### BACKGROUND OF THE INVENTION

Satellite Digital Audio Radio Service (SDARS) is a system that broadcasts content such as CD-quality music and other audio programming to terrestrial mobile receivers via direct broadcast satellites supplemented by gap-filler terrestrial networks. The SDARS system operates over the licensed spectrum in the S-band and employs time, frequency and space diversity to provide maximum service continuity. Service is by subscription with the capability for selective tiered service.

In order to access SDARS content, a listener must purchase a subscription from a SDARS content provider and acquire an SDARS receiver capable of receiving the content. SDARS receivers are now available as an option in most types of new cars as well as stand-alone receivers which can be plugged in to a car or home theatre audio system. Additionally, SDARS audio content can be accessed over the internet.

In order to maintain a strong broadcast signal to a moving SDARS receiver, the SDARS system employs frequency and space diversity which is achieved by broadcasting the SDARS content through three separate but redundant signal streams, each from a different source, and each in a different frequency band. Additionally, the streams incorporate built-in delays relative to each other in order to achieve time diversity. A SDARS receiver picks up all three of the broadcast signals and combines them to form a single composite signal that is decoded and broadcast to the listener. The combining of three distinct and diverse signals helps to maintain audio quality when the SDARS receiver passes under bridges, through tunnels, or encounters other obstacles in receiving the individual signals broadcast by the SDARS system.

FIG. 1 shows a conventional SDARS system 100. The SDARS system 100 broadcasts in the S-band frequency block, which has a bandwidth of 12.5 MHz and is centered at 2326.35 MHz (see FIG. 2). Two of the SDARS signal streams, TDM1 and TDM2, are sent via satellites 102a and 102b, respectively, using a Time Division Multiplexed (TDM) mode, each in a separate frequency band that is a sub-band of the S-band. The third signal, OFDM, is first sent via a Very Small Aperture Terminal (VSAT) satellite link 104 to terrestrial repeaters 106 that then broadcast in a third sub-band of the S-band using a Coded Orthogonal Frequency Division Multiplexed (COFDM) mode. A SDARS receiver 108 receives the three signals TDM1, TDM2 and OFDM and converts them into an audio signal that is broadcast to a listener.

Space diversity in the SDARS system is achieved by having three physically separate transmission paths for delivering the three SDARS signals to the mobile receiver 108. A SDARS receiver requires only one of the three signals for operation since each signal includes the full composite signal of audio and control. When more than one of the signals is present, they are combined which results in the additional advantages of diversity gain, elimination of temporary blockages of any individual signal, and seamless transitions when entering or leaving geographic regions that have terrestrial network coverage.

The two satellite signal paths TDM1 and TDM2 are provided by two active satellites 102a, 102b broadcasting at all times, each of which is fed by its own uplink signal. Satellite orbits are offset in phase such that the satellites are at different elevation and azimuth angles, minimizing the likelihood that both satellite paths will be blocked simultaneously. The third signal path, OFDM, is transmitted through terrestrial repeaters 106, which are used as gap fillers in areas where the satellite signals are likely to be blocked, such as large metropolitan areas.

Frequency diversity in the SDARS system is achieved by having the three physical signal paths occupy different sub-bands within the 12.5 MHz wide band licensed to the Satellite Radio provider as shown in FIG. 2. The two TDM signals, TDM1 and TDM2, occupy the upper and lower frequency sub-bands while the OFDM signal occupies the middle sub-band. The SDARS receiver requires only one of the three signals for operation since each signal includes the full composite signal of audio and control. Filtering and independent demodulators are included in the receiver to independently recover each of the signals. Once recovered, the signals are combined, taking into account their signal level and quality. Corruption in a small portion of the spectrum would not degrade all three signals so that the receiver would still be able to recover the full composite signal.

As shown in FIG. 3, time diversity in the SDARS system is achieved by intentionally inserting identical delays (approximately 4 seconds) into two of the three signal paths, TDM2 and OFDM, prior to transmission. FIG. 3A illustrates the timing of the TDM1 and TDM2 signals at the transmitter. The undelayed TDM1 signal is delayed by the identical amount in the receiver to facilitate combining of the three signals, as shown in FIG. 3B. FIG. 3C shows the combined signal resulting from the broadcast signals TDM1 and TDM2. As a result, temporary blocking or corruption of the input signals to the receiver results in low signal quality at different relative temporal instants in the delayed vs. undelayed signals (see FIGS. 4A, 4B and 4C). When the signals are re-aligned in the receiver for combining, the corruption (low signal quality) will appear at different instants at the inputs to the combiner.

A drawback of a conventional SDARS receiver is the high rate of power consumption needed to continually receive and decode the three input signals. It would be desirable for a SDARS receiver to have a low-power mode of operation in order to decrease the cost of operation of the device.

### SUMMARY OF THE INVENTION

The present invention implements a method and system for receiving content in a Satellite Digital Audio Radio Service (SDARS) system. The method includes receiving a first signal stream in an SDARS receiver, the first signal stream including the SDARS content. The method further includes receiving a second signal stream in the SDARS receiver, the second signal stream including the SDARS content, the second signal stream being delayed relative to the first signal stream by a predetermined delay time. The method further includes combining the first signal stream and the second signal stream in to a composite signal that includes the SDARS content. The method further includes powering off a portion of the SDARS receiver, wherein the powering off of the portion of the SDARS receiver does not cause a disruption in the composite signal.

### BRIEF DESCRIPTION OF THE DRAWINGS

FIG. 1 shows a conventional SDARS system 100.

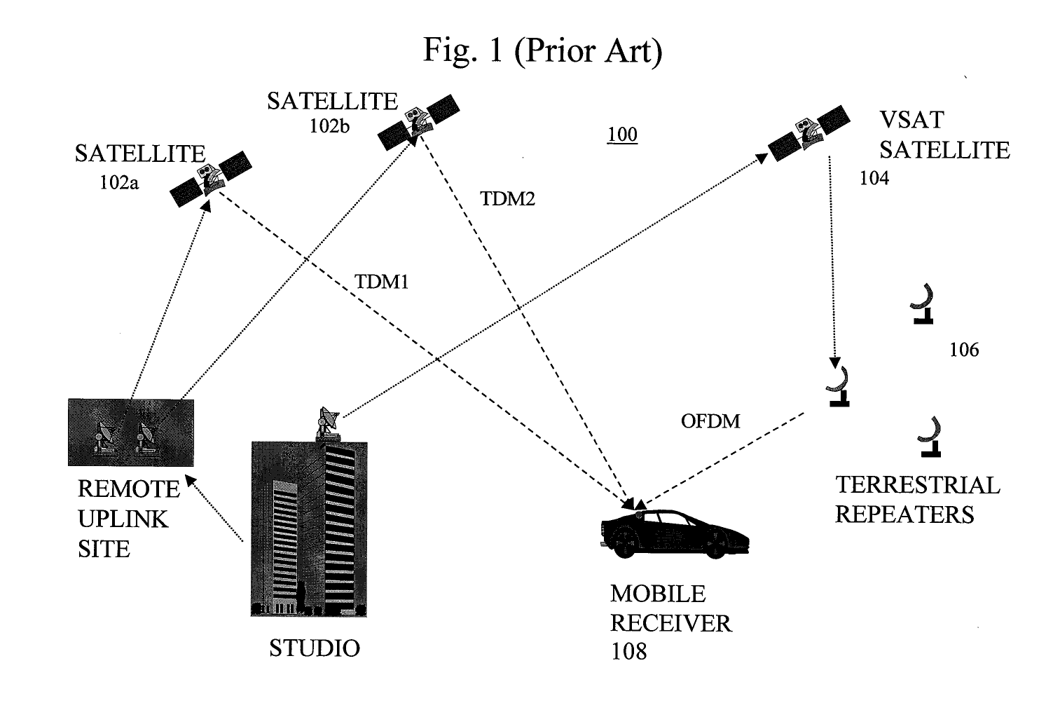

FIG. 2 shows the frequency bands of the TDM1, TDM2 and OFDM signals in a SDARS system.

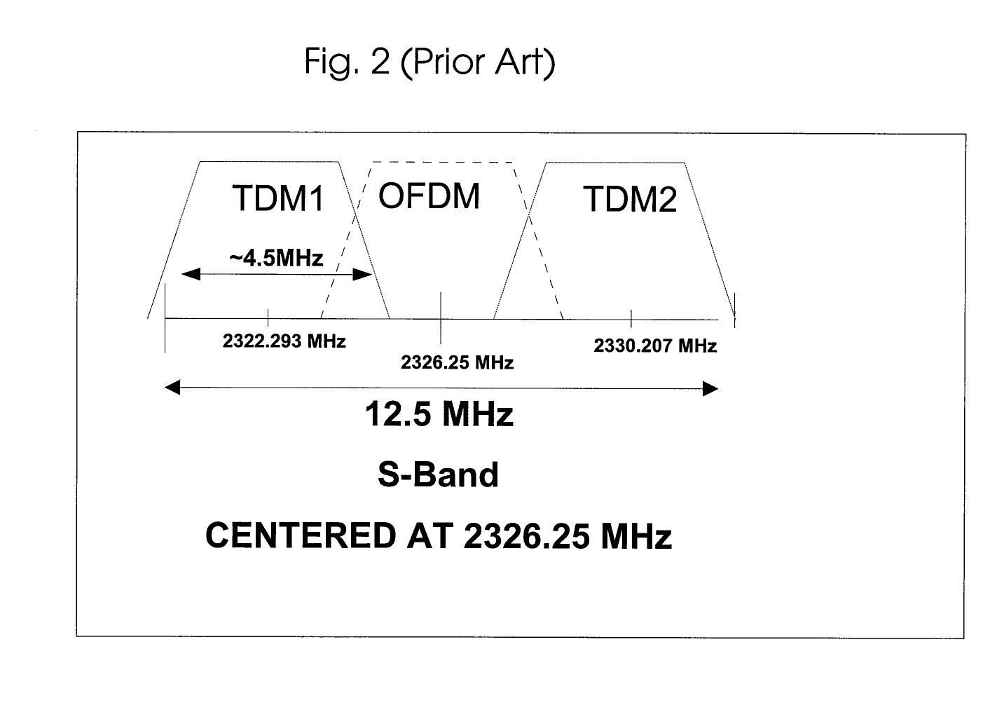

FIG. 3 shows the timing of TDM1, TDM2 and OFDM signals in a SDARS system.

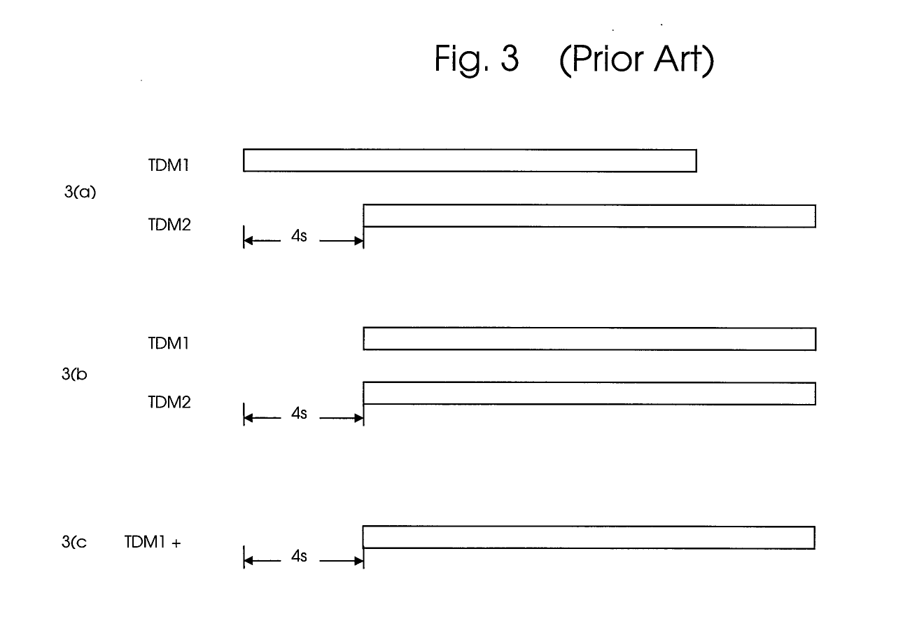

FIGS. 4A, 4B and 4C show the timing of the TDM1 and TDM2 signals of one embodiment of a SDARS system according to the present invention.

FIGS. 5A, 5B and 5C show the timing of the TDM1 and TDM2 signals of a SDARS system according to the embodiment of FIGS. 4A, 4B, and 4C in the ideal case where both the TDM1 and TDM2 signals maintain sufficient signal quality at all times.

FIG. 6 shows a block diagram of one embodiment of an SDARS receiver 600 according to the present invention.

### DETAILED DESCRIPTION OF THE INVENTION

The present invention implements a method and system for a low-power, burst mode of operation for an SDARS receiver by taking advantage of the redundancy in time diversity in the SDARS system. The power consumption of the SDARS receiver is reduced by monitoring the coverage of the individual input signals and, when the signal coverage of the individual streams appears to be good enough to maintain audio quality, periodically turning off the power of the analog front-end and associated part of the digital receiver for up to 4 seconds.

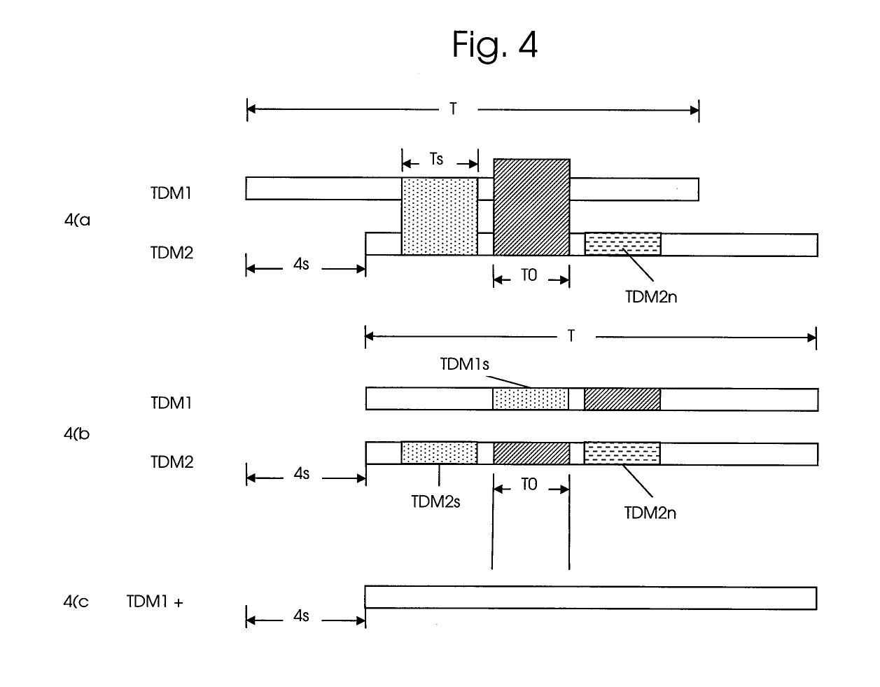

FIGS. 4A, 4B and 4C show the timing of the TDM1 and TDM2 signals of one embodiment of a SDARS system according to the present invention. FIG. 4A shows the timing of the TDM1 and TDM2 signals received by the SDARS receiver with TDM2 delayed by 4 seconds from the transmitter side. During a sampling period Ts, the quality of the TDM1 and TDM2 signals is evaluated in order to determine whether each of the signals is sufficient to maintain audio quality by itself. For example, a threshold level of Signal to Noise Ratio (SNR) of the received signals TDM1 and TDM2 can be used to judge the signal quality. If both of the TDM1 and TDM2 signals are determined to be sufficient, the SDARS receiver is powered off for T0 seconds during which time neither the TDM1 nor the TDM2 signal is received by the SDARS receiver. T0 must be less than 4 seconds to prevent audio disruption.

FIG. 4B shows the timing of the TDM1 and TDM2 signals after TDM1 is delayed by 4 seconds by passing the TDM1 data through a 4 second delay buffer in the receiver and FIG. 4C shows the composite (TDM1+TDM2) signal that is the result of combining the TDM1 and TDM2 signals. As shown in FIG. 4B, the TDM1s portion of the TDM1 signal that was received during the sampling period Ts includes the same SDARS content that was included in the TDM2 signal during the time period T0 where the SDARS receiver was powered off. Because the TDM1s portion of the TDM1 signal was determined to be sufficient to maintain audio quality during the sampling period Ts, the composite signal shown in FIG. 4C suffers no disruption during that time period.

FIGS. 4A and 4B also show the TDM2ns portion of the TDM2 signal that corresponds to the portion of the TDM1 signal that occurs during the time period T0 that the SDARS receiver is powered off. Because the TDM2ns portion of the TDM2 has not been received yet at the time the receiver is powered off, the receiver is unable to determine, for certain, whether the TDM2ns portion of the TDM2 signal will be sufficient to maintain audio quality by itself. However, as shown in FIG. 4A, the turn off period T0 is less than 4 seconds and occurs right after the sampling period Ts. Therefore, the TDM2s portion of the TDM2 signal that was sampled during the sampling period Ts can be used as a reasonably accurate predictor of the signal quality during the TDM2ns portion of the TDM2 signal. If the TDM2s portion of the TDM2 signal is determined to be sufficient, it is likely that no disruption will occur while the TDM2ns portion of the TDM2 signal is received by the SDARS receiver. Thus, the composite signal shown in FIG. 4C suffers no disruption during the time period while the TDM1 signal was not received. Therefore, the composite signal shown in FIG. 4C is a continuous audio signal, such that audio quality is maintained. In other preferred embodiments of the present invention, time period Ts of sampling the TDM1 and TDM2 signals may be longer or shorter than the duration of the turn off period T0 of the SDARS receiver. Additionally, the determination of the signal quality of the TDM1 and/or TDM2 signals may be based on a single sampling period Ts or a combination of more than one period of sampling.

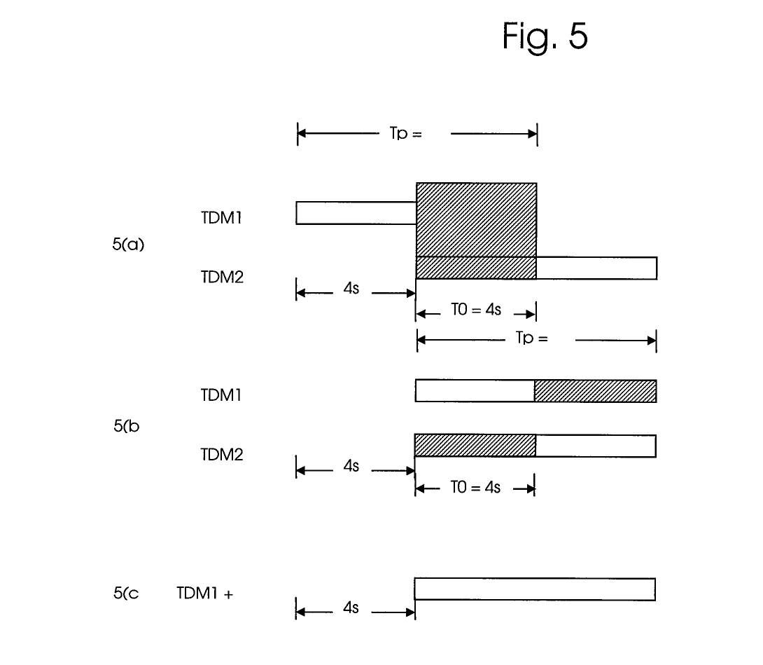

FIGS. 5A, 5B and 5C show the timing of the TDM1 and TDM2 signals of a SDARS system according to the embodiment of FIGS. 4A, 4B, and 4C in the ideal case where both the TDM1 and TDM2 signals maintain sufficient signal quality at all times. In that case, the power can be turned off for a length of time which is nearly equal to the 4 second delay. Audio quality is maintained in the composite output signal because each of the TDM1 and TDM2 signals is sufficient to reproduce the output signal. Because the SDARS receiver is turned off for half of the signal period Tp, the power consumption savings in the turned-off portions of the SDARS receiver in the ideal case is (T0/Tp)=50% relative to conventional receiver.

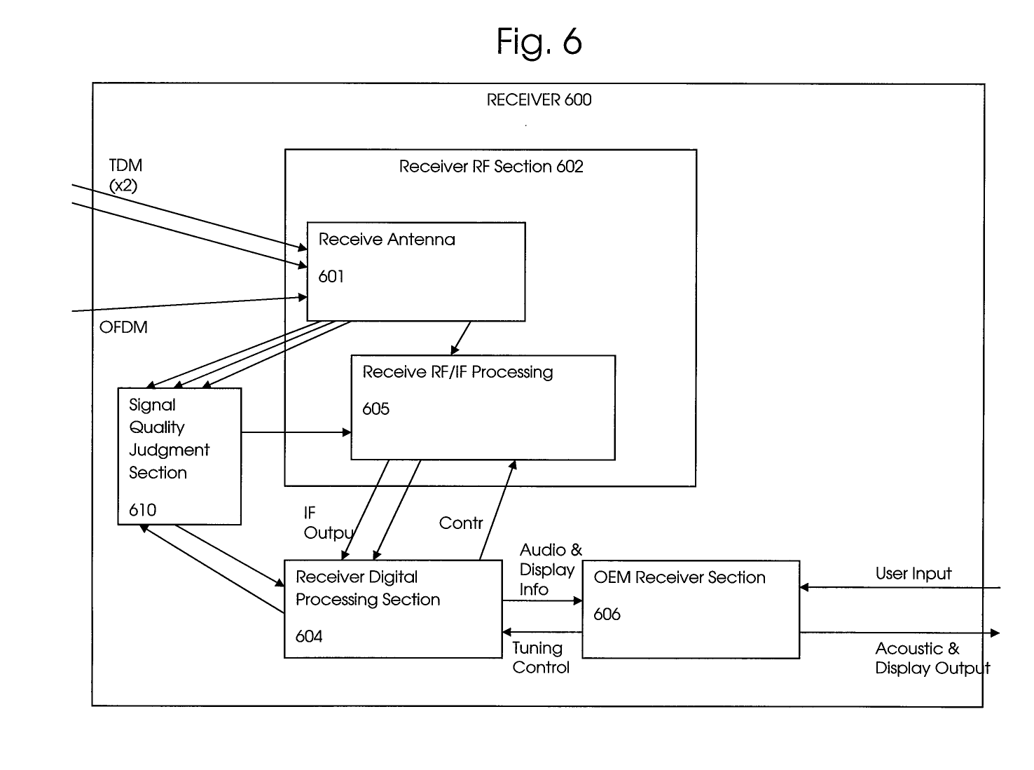

FIG. 6 shows a block diagram of one embodiment of an SDARS receiver 600 according to the present invention. The SDARS receiver 600 includes a receiver RF section 602 that receives the TDM1, TDM2 and OFDM broadcast signal streams. The receiver RF section 602 includes a receive antenna 601 and a RF to IF processing section 605. The SDARS receiver 600 further includes a receiver digital processing section 604 and an Original Equipment Manufacturer (OEM) receiver section 606. The receiver RF section 602 performs RF/IF processing on the input signals in the RF to IF processing section 605 and transmits an IF output signal to the receiver digital processing section 604. The receiver digital processing section 604 performs digital processing on the IF output signal and transmits an audio and display information signal to the receiver section 606. Additionally, the receiver digital processing section 604 receives a tuning control signal from the receiver section 606. The receiver section 606 performs the user-interface functions of the receiver 600, such as receiving a user input signal and transmitting the acoustic and display output.

The SDARS receiver 600 further includes signal quality judgment section 610 that judges whether the quality of each of the TDM1, TDM2 and OFDM signals is sufficient to maintain audio quality by itself. If the TDM1 and either the TDM2 or the OFDM signals are determined to be sufficient, the signal quality judgment section 610 sends a control signal to power off the RF to IF processing section 605 and the receiver digital processing section 604 for T0 seconds by, for example, disabling the clock signals in those blocks. The OEM receiver section 606 maintains power during the power-off period T0 in order to maintain user-interface functionality.

FIG. 6 is a functional block diagram. Therefore, it should be understood that the blocks in FIG. 6 represent a logical partitioning of the tasks performed in accordance with the invention, and does not necessarily represent a hardware partitioning. It also should be understood that the tasks described in connection with FIG. 6 may be performed by software, hardware, firmware, state machines, digital signal processors, microprocessors, programmed general purpose processors or computers, or any combinations of the above.

Additional alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A method for receiving content in a Satellite Digital Audio Radio Service (SDARS) system comprising:
receiving a first signal stream in an SDARS receiver, the first signal stream including the SDARS content;
receiving a second signal stream in the SDARS receiver, the second signal stream including the SDARS content, the second signal stream being delayed relative to the first signal stream by a predetermined delay time;
combining the first signal stream and the second signal stream in to a composite signal that includes the SDARS content; and
powering off a portion of the SDARS receiver,
wherein the powering off of the portion of the SDARS receiver does not cause a disruption in the composite signal.

2. The method of claim 1, further comprising:
judging the quality of the first and second signal streams; and
powering off the portion of the SDARS receiver based on whether the first and second signal streams meet a quality threshold.

3. The method of claim 2 wherein the quality of each of the first and second signal stream is judged based on the signal to noise ratio of each signal stream, respectively.

4. The method of claim 2 wherein the quality of each of the first and second signal stream is judged based on the channel decoding error indicator of each signal stream, respectively.

5. The method of claim 1 wherein the SDARS receiver is powered off for a time interval that is less than the predetermined delay time.

6. The method of claim 1, further comprising:
receiving a third signal stream in the SDARS receiver, the third signal stream including the SDARS content; and
combining the first signal stream, the second signal stream and the third signal stream into a composite signal that includes the SDARS content, the third signal stream being delayed relative to the first signal stream by the predetermined delay time.

7. The method of claim 6, further comprising:
judging the quality of the first, second and third signal streams; and
powering off the portion of the SDARS receiver based on whether the first signal stream and at least one of the second and third signal streams meet a quality threshold.

8. A SDARS receiver for receiving content in a Satellite Digital Audio Radio Service (SDARS) system comprising:
one or more receive antennas that receive a first signal stream and a second signal stream, the first signal stream including the SDARS content, the second signal stream including the SDARS content, the second signal stream being delayed relative to the first signal stream by a predetermined delay time; and
a signal processer that combines the first signal stream and the second signal stream into a composite signal that includes the SDARS content, wherein a portion of the SDARS receiver is powered off for a predetermined period of time, and wherein the powering off of the portion of the SDARS receiver does not cause a disruption in the composite signal.

9. The SDARS receiver of claim 8, further comprising:
a signal quality judgment section that judges the quality of the first and second signal streams,
wherein the portion of the SDARS receiver is powered off based on whether the first and second signal streams meet a quality threshold.

10. The system of claim 9 wherein the quality of each of the first and second signal stream is judged based on the signal to noise ratio of each signal stream, respectively.

11. The system of claim 9 wherein the quality of each of the first and second signal stream is judged based on the channel decoding error indicator of each signal stream, respectively.

12. The system of claim 8 wherein the SDARS receiver is powered off for a time interval that is less than the predetermined delay time.

13. The system of claim 8, wherein the one or more receive antennas receive a third signal stream, the third signal stream including the SDARS content, the third signal stream being delayed relative to the first signal stream by the predetermined delay time, and wherein the signal processer combines the first signal stream, the second signal stream and the third signal stream into a composite signal that includes the SDARS content, wherein a portion of the SDARS receiver is powered off for a predetermined period of time, and wherein the powering off of the portion of the SDARS receiver does not cause a disruption in the composite signal.

14. The system of claim 13, wherein the signal quality judgment section judges the quality of the first, second and third signal streams, and wherein the portion of the SDARS receiver is powered off based on whether the first signal stream and at least one of the second and third signal streams meet a quality threshold.
